(19) United States
(12) Patent Application Publication
(10) Pub. No.: US 2005/0222983 A1
(43) Pub. Date: Oct. 6, 2005

(54) Data structure for fast case-sensitive and insensitive search

(76) Inventor: Holger Schwedes, Bruchsal (DE)

Correspondence Address: FISH & RICHARDSON, P.C., PO BOX 1022, MINNEAPOLIS, MN, 55440-1022, US

(21) Appl. No.: 10/815,964

(22) Filed: Mar. 31, 2004

(51) Int. Cl. G06F 7/00

(52) U.S. Cl. 707/3

(57) ABSTRACT

A system and method to facilitate fast and efficient implementation of case-sensitive and insensitive search using a search engine on a dictionary and using one or more search terms. The dictionary comprises an ordered list of terms. In one implementation a dictionary sorting function is set to sort the ordered list of terms based on case sensitivity. According to the dictionary sorting function, it is determined whether a term corresponding to a search term is in an upper or lower half of the ordered list. Then an upper or lower half of the ordered list that includes the search term is selected.

### BACKGROUND

When using a search engine or similar technology to search in an information system for a certain term, which may be either a single word or a phrase, a user enters a string of characters. The string of characters may include a specific combination of uppercase and lowercase letters.

Where letters are used for the search term, a number of cases are possible. In one case, the user wishes to retrieve only documents containing the search term with the specific combination of uppercase and lowercase letters. In this case, the user wishes to perform a “case-sensitive” search. In another case, the user wishes to retrieve all documents containing variants of the search term with any combination of uppercase and lowercase letters. In this case, the user wishes to perform a “case-insensitive” search. The search engine should enable the user to choose which kind of search to perform, without sacrificing speed or efficiency.

In one example, a search term includes a string of characters. In the search system, a dictionary stores a list of all acceptable terms for a string attribute. Logically, the dictionary is a sorted list of strings. In the example, let the dictionary include the set of terms {“ADAM”, “Adam”, “adam”}. Corresponding search results are exemplified below:

| | | | |
|---|---|---|---|
| A case-sensitive search for | “Adam” | finds | {“Adam”}. |
| A case-sensitive search for | “AdAM” | finds | { }. |
| A case-sensitive search for | “adam” | finds | {“adam”} |
| A case-insensitive search for | “Adam” | finds | {“ADAM”, “Adam”, |
| | | | “adam”} |
| A case-insensitive search for | “AdAM” | finds | {“ADAM”, “Adam”, |
| | | | “adam”} |
| A case-insensitive search for | “adam” | finds | {“ADAM”, “Adam”, |
| | | | “adam”} |

Conventional techniques for implementing case-sensitive searches are fast and efficient. However, techniques for implementing case-insensitive search on the same dictionary may be much slower and less efficient, since standard dictionary orderings of terms in the index for a document collection may not group variants of terms with different uppercase and lowercase spellings together. Case-insensitive search on a different dictionary can be fast, but this requires maintenance of two separate dictionaries, which is inefficient.

There exists a need to raise the speed and efficiency of case-insensitive search by defining a dictionary implementation that enables comparably fast sensitive and insensitive search to be performed on the same list of terms in a dictionary.

### SUMMARY

This document discloses a method and system to define a dictionary sorting function that orders terms case-insensitively into blocks that are equivalent except for case variations, then order blocks of equivalent terms such that variants with uppercase letters precede variants with lowercase letters.

In accordance with an embodiment, a method of fast case-sensitive search of a dictionary using one or more search terms is disclosed. The dictionary includes an ordered list of terms. The method includes setting a dictionary sorting function to sort the ordered list of terms based on case sensitivity, and determining, according to the dictionary sorting function, whether a term corresponding to a search term is in an upper or lower half of the ordered list. The method further includes selecting an upper or lower half of the ordered list that includes the search term.

In accordance with another embodiment, a system for fast case-sensitive search of the dictionary includes a search engine configured to receive a user search query for a search of the dictionary, and to return a search result list. The search engine is further configured to enable a user to select whether to perform a case-sensitive or case-insensitive search of the dictionary. The system further includes an ordering module configured to order the terms in the dictionary based in part on the binary numbers corresponding to the ASCII coding of alphanumeric characters comprising the terms in the dictionary.

The details of one or more embodiments are set forth in the accompanying drawings and the description below. Other features, objects, and advantages will be apparent from the description and drawings, and from the claims.

### BRIEF DESCRIPTION OF THE DRAWINGS

These and other aspects will now be described in detail with reference to the following drawings.

FIG. 1 shows an example of a system for fast case-sensitive or case-insensitive search of a dictionary.

FIG. 2 illustrates one example method of a case-sensitive search.

FIG. 3 illustrates one example method of a case-insensitive search.

FIG. 4 illustrates another example method of a case-insensitive search.

Like reference symbols in the various drawings indicate like elements.

### DETAILED DESCRIPTION

A method and system is disclosed that defines a dictionary sorting function that orders terms case-insensitively into blocks that are equivalent except for case variations. Then, blocks of equivalent terms are ordered such that variants with uppercase letters precede variants with lowercase letters. In one implementation, the dictionary includes appropriate case-oriented spelling variants of each term.

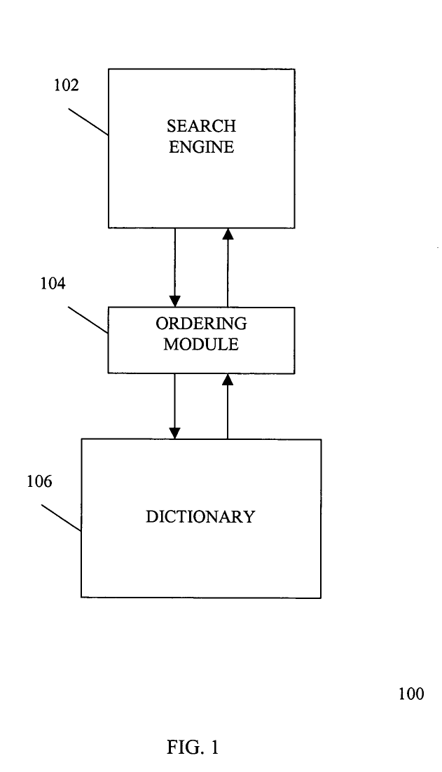

FIG. 1 shows a system 100 that includes a search engine 102 configured to receive a user search query for a search of a dictionary 106 and to return a search result list. In accordance with an exemplary embodiment, the search engine 102 is further configured to enable a user to select whether to perform a case-sensitive or case-insensitive search of the dictionary 106. The dictionary 106 is a stored list of all terms for a string attribute. Logically, the dictionary 106 is a sorted list of strings. An ordering module 104 is configured to order the entries in the dictionary 106 similar to a numerical sort on the basis of the binary numbers corresponding to the ASCII coding of alphanumeric characters, and in particular the binary differences between upper and lower cases of the ASCII codes of those alphanumeric characters.

A resulting order of the ordering module 104 includes a dictionary sorting function LT that is case-insensitive, with blocks of equivalent case-insensitive words. For blocks of equivalent case-insensitive words, the order can be uppercase letters before lowercase letters. Table 1 illustrates one type of LT ordering of an example result for the word “ADAM.” In practice, the dictionary 106 can include only those case variants that actually appear in the indexed documents, on not every possible variant of a word.

TABLE 1

| | |
|---|---|
| . . . | ADAM |
| adA | aDAm |
| ada | aDaM |
| . . . | aDam |
| adal | adAM |
| ADAM | adAm |
| ADAm | adaM |
| AdaM | adam |
| Adam | ADAN |
| AdAM | . . . |
| AdAm | ADAMA |
| AdaM | ADAMa |
| Adam | . . . |

The dictionary sorting function LT is defined for two strings x and y such that: LT(x, y) if and only if x precedes y in a dictionary ordering. Various implementations of the dictionary sorting function LT are possible using various programming languages or techniques. In “infix” notation: x<y iff x precedes y in the dictionary, and LT(x, y) iff x<y.

Typical ASCII sorting does not list the different spellings of a term together in the dictionary, so it cannot be used to perform a fast search. Example:

“ADAM”<“BOBBY”<“adam”

Accordingly, the dictionary sorting function LT includes a parameter sensitive with possible values true and false. If sensitive=false, all case variants of “Adam” are equivalent under LT.

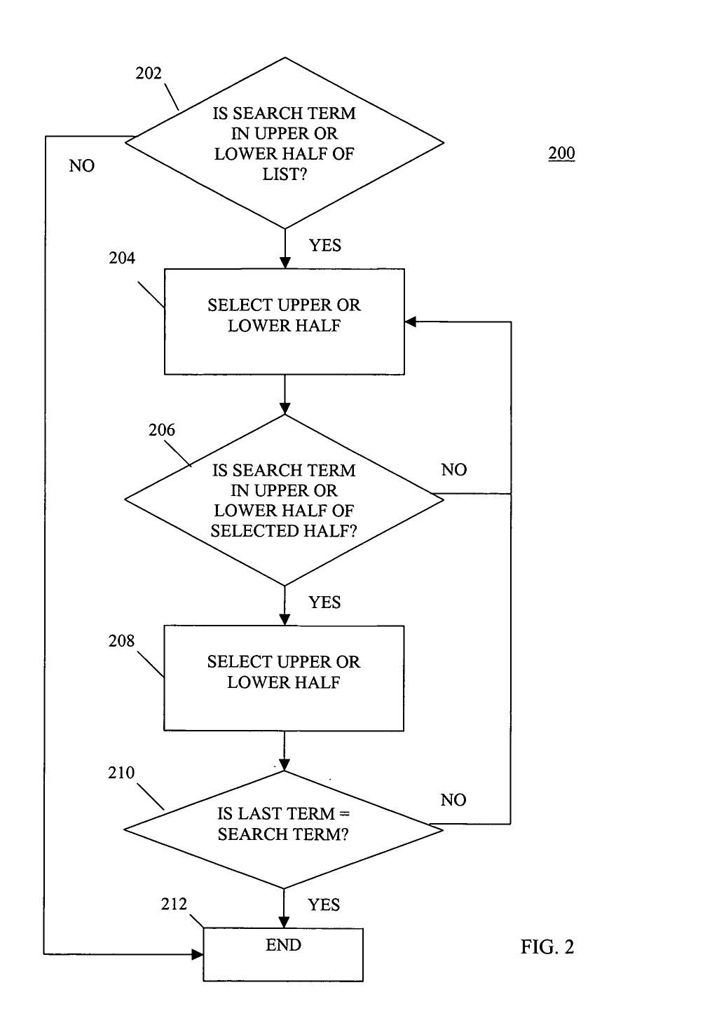

In an exemplary embodiment, a case-sensitive search is performed as a normal binary search in a list of all terms. FIG. 2 shows a case-sensitive search. At 202, a determination is made whether a search term should be in upper or lower half of the list. At 204, the upper or lower half is selected. At 206, a determination is made whether the search term is in the upper or lower half of the selected half. At 208, the upper or lower half of the half is selected. These steps are repeated until there is only one term in the selected half. If there is only one term in the selected half, then at 210, a determination is made whether the one term is the search term. If yes the method ends at 212. To compare terms, the function LT is used with parameter sensitive=true.

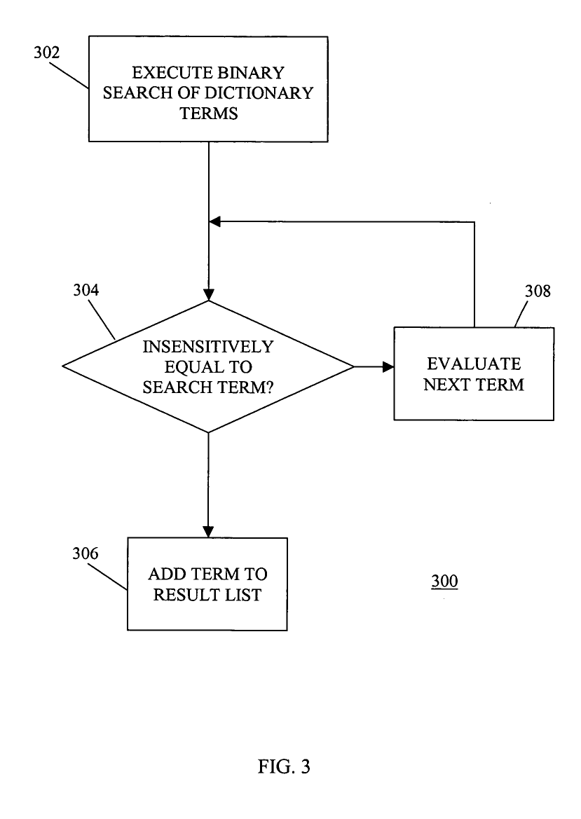

In an alternative exemplary embodiment, a case-insensitive search can be performed in several ways. FIG. 3 shows a first method 300 for a case-insensitive search. At 302 a binary search for the start of the insensitively equal terms in the dictionary listing is executed. To compare terms, the function LT is used with parameter sensitive=false. At 304, for each term an evaluation is made whether it is insensitively equal to the search term. If so, at 306, that term is added to the result list. If not, a next term is evaluated at 308. While each term can be evaluated one-by-one, these steps may be performed on blocks of two or more terms.

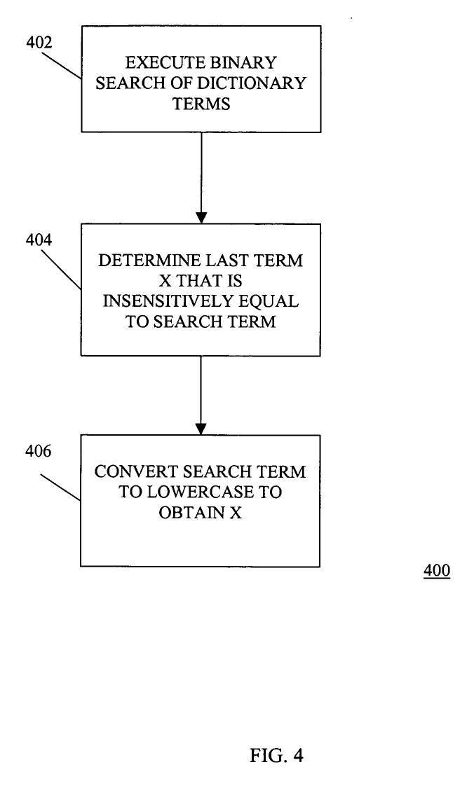

FIG. 4 shows a second method 400 for a case-insensitive search. At 402 a binary search for the start of the insensitively equal terms in the dictionary listing is executed. To compare terms, the function LT is used with parameter sensitive=false, as with 302 in FIG. 3. At 404, a binary search in the dictionary is made for each term to determine the last term X that is still insensitively equal to the search term. Given a dictionary ordering of uppercase before lowercase, at 406 the last term X is obtained from the search term by converting the search term into lowercase letters. All terms between the start found in 402 and the term X found at 406 are the result set. As with method 300, these steps may be performed on blocks of two or more terms in parallel.

In sum, the function LT ensures that case-insensitively equal terms stand together in the dictionary: terms are first compared insensitively. If case-insensitively equal, they are then compared case-sensitively. Where n=number of terms in the dictionary (which may be many millions), k=average number of characters in a search string (a small fixed number, such as 10), and m=number of different spelling variants for a term (where maximum value is about 2\hat{ }k, such as 1000), the case-sensitive search described at 200 above yields a result: O(log2(n)*k)—>O(log(n)).

The case-insensitive search of method 300 yields a result: O(log2(n)*k+m*k)—>O(log(n)). The case-insensitive search described with respect to method 400 yields a result: O(2*log2(n)*k)—>O(log(n)).

Although a few embodiments have been described in detail above, other modifications are possible. Rearrangement of the logic flows depicted in FIGS. 2-4 are within the scope of the embodiments described therein. Other embodiments may be within the scope of the following claims.

1. A method of fast case-sensitive search of a dictionary using one or more search terms, wherein the dictionary comprises an ordered list of terms, the method comprising:
setting a dictionary sorting function to sort the ordered list of terms based on case sensitivity;
determining, according to the dictionary sorting function, whether a term corresponding to a search term is in an upper or lower half of the ordered list; and
selecting an upper or lower half of the ordered list that includes the search term.

2. A method in accordance with claim 1, further comprising determining whether the term corresponding to the search term is in an upper or lower half of a previously-selected upper or lower half of the ordered list.

3. A method in accordance with claim 2, further comprising selecting an upper or lower half of the previously-selected upper or lower half of the ordered list that includes the search term.

4. A method in accordance with claim 3, further comprising determining whether the term corresponding to a search term is a last term in an upper or lower half of a remaining ordered list.

5. A method in accordance with claim 4, further comprising, if the term corresponding to a search term is the last term in an upper or lower half of the remaining ordered list, returning the term to a search engine.

6. A method of fast case-insensitive search of a dictionary using one or more search terms, wherein the dictionary comprises an ordered list of terms, the method comprising:
setting a dictionary sorting function to sort the ordered list of terms based on case-insensitivity; and
executing a binary search of the dictionary according to the dictionary sorting function and based on the binary numbers corresponding to the ASCII coding of alphanumeric characters in the ordered list of terms.

7. A method in accordance with claim 6, further comprising determining whether each term in the ordered list is insensitively equal to a search term.

8. A method in accordance with claim 7, further comprising, if a term in the ordered list is insensitively equal to a search term, adding the term to a result list.

9. A method in accordance with claim 7, further comprising, if a term in the ordered list is not insensitively equal to a search term, evaluating a next term in the ordered list.

10. A method in accordance with claim 8, further comprising:
compiling one or more terms in the result list; and
returning the result list to a search engine.

11. A method in accordance with claim 6, further comprising determining a last term of the ordered list that is insensitively equal to a search term.

12. A method in accordance with claim 11, further comprising converting the search term to all lowercase characters to obtain the last term.

13. A system for fast case-sensitive search of a dictionary using one or more search terms, wherein the dictionary comprises an ordered list of terms, the system comprising:
a search engine configured to receive a user search query for a search of the dictionary, and to return a search result list, and wherein the search engine is further configured to enable a user to select whether to perform a case-sensitive or case-insensitive search of the dictionary; and
an ordering module configured to order the terms in the dictionary based in part on the binary numbers corresponding to the ASCII coding of alphanumeric characters comprising the terms in the dictionary.

14. A system in accordance with claim 13, wherein the ordering module comprises a dictionary sorting function that sorts the ordered list of terms based on case-sensitivity or case-insensitivity in accordance with a user selection from the search engine.
